(19) United States
(12) Patent Application Publication
(10) Pub. No.: US 2006/0054370 A1
(43) Pub. Date: Mar. 16, 2006

(54) Tiltable three-wheeled vehicle

(75) Inventors: Koichi Sugioka, Wako-shi (JP); Hiroshia Takahashi, Wako-shi (JP); Akira Hayashi, Wako-shi (JP); Katsuichi Yagisawa, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/211,716

(22) Filed: Aug. 26, 2005

(30) Foreign Application Priority Data
Aug. 27, 2004 (JP) 2004-249102

(51) Int. Cl. B62D 61/06

(52) U.S. Cl. 180/211

(57) ABSTRACT

A tiltable three-wheeled vehicle is provided having left and right front wheels, a rear wheel, and a tilting mechanism. The vehicle includes a center frame extending in the lengthwise direction of the vehicle, a rotary member provided on the frame, a floor plate and a cross shaft attached to the rotary member, a power unit, and a manipulating member that is provided on a front portion of the frame. The cross shaft crosses the frame at a right angle and the left and right front wheels are provided on the ends of the cross shaft, The rear wheel is provided on a rear portion of the frame by way of the power unit. The front wheels maintain a zero camber. The frame and the rear wheel constitute a tiltable portion by means of the rotary member with respect to said left and front wheels and the floor plate.

### FIELD OF INVENTION

The present invention relates to a tiltable three-wheeled vehicle which can perform a turning operation using a camber (an inclination of a wheel as viewed from a front side of the wheel) of a rear wheel and the steering of a front wheel.

### BACKGROUND OF THE INVENTION

In general, a tiltable three-wheeled vehicle which performs a turning operation by inclining wheels by making use of a camber of the wheels is known. See, for example, U.S. Pat. No. 1,505,224 (the '224 patent.)

FIG. 1 of the '224 patent is a perspective view of a tiltable vehicle, wherein the tiltable vehicle 12 (symbol used in the publication being used without modification, other parts being indicated in the same manner hereinafter) is a three-wheeled vehicle which raises side links 90, 92 from left and right trailing arms 56, 58 which extend in the fore-and-aft direction and includes a front wheel 34 which is mounted on a frame 14 by way of a bell crank 94 and a knob 108 and rear wheels 72, 74. A driver imparts a camber to the wheels 34, 72, 74 by changing loads which are applied to left and right step-on pads 76, 78 whereby the vehicle 12 is turned. However, because the steering portion includes an engine 36 mounted on the front wheel 34, inertia of the steering portion is increased.

Thus, there has been a demand for the enhancement of the turning performance at a fixed speed or more. There has also been a demand for a steering wheel having a small diameter.

Accordingly, it is an object of the present invention to provide a tiltable three-wheeled vehicle with improved turning performance and that is self-standing in accordance with a driver's intention.

### SUMMARY OF THE INVENTION

The present invention addresses the above described conditions. According to one embodiment of the present invention, a tiltable three-wheeled vehicle is provided having left and right front wheels, one rear wheel, a tilting mechanism between the rear wheel and the front wheels, and a center frame which extends in the fore-and-aft direction of the vehicle. A rotary member is also mounted in a position that the rotary member is rotatable about an axis of the center frame, wherein a floor plate, which supports a driver, and a cross shaft, which crosses the center frame at a right angle, are fixed to the rotary member. The left and right front wheels are mounted on left and right ends of the cross shaft and one rear wheel is mounted on a rear portion of the center frame by way of a power unit. A manipulating member which the driver manipulates is erected on a front portion of the center frame. The front wheels maintain a zero camber, and the center frame and the rear wheel comprise a tiltable portion with respect to the front wheels and the floor plate by way of the rotary member.

Thus, because the manipulating member is fixed to the front portion of the center frame and one rear wheel is mounted on the rear portion of the center frame by way of the power unit and hence, the rear wheel is tilted by an amount that the manipulating member is inclined. Accordingly, when the manipulating member is erected upright, a camber of one rear wheel becomes zero. Also, because cambers of the left and right front wheels maintain zero, the vehicle body can be made self-standing in accordance with a driver's intension when the vehicle is stopped.

Further, because one rear wheel is configured to be tilted in the turning direction by tilting the manipulating member in either a left side or a right side, t the vehicle exhibits improved turning performance.

According to another embodiment of the present invention, the left and right front wheels are steerably mounted on the cross shaft, tie rods extend in the left-and-right direction from a front portion of the center frame or a lower portion of the manipulating member, and the tie rods are connected with the left and right front wheels, whereby two front wheels are configured to be steered when the manipulating member is inclined to the left or to the right.

Thus, because the vehicle is configured such that the left and right front wheels can be steered and one rear wheel can be tilted in the turning direction, it is possible to direct all three wheels in the turning direction, which improves the turning performance.

### BRIEF DESCRIPTION OF THE DRAWINGS

The preferred embodiments of the present invention are shown by way of example and not limitation in the accompanying figures, wherein:

FIG. 1 is a perspective view of a tiltable three-wheeled vehicle according to the present invention,

FIG. 2 is a side view of the tiltable three-wheeled vehicle according to the present. invention;

FIG. 3 is a view as viewed from the direction of an arrow 3 in FIG. 2;

FIG. 4 is a cross-sectional view taken along a line 4-4 in FIG. 2;

FIG. 5 is a cross-sectional view taken along a line 5-5 in FIG. 2;

FIG. 6 is an operational view of the tiltable three-wheeled vehicle when the rear wheel is tilted;

FIG. 7 is a cross-sectional view taken along a line 7-7 in FIG. 2;

FIG. 8 is a cross-sectional view taken along a line 8-8 in FIG. 3;

FIG. 9 is an operational view showing a state in which front wheels are steered when a frame is tilted;

FIG. 10 is an operational view of a tiltable three-wheeled vehicle;

FIG. 11 is an operational view for explaining that a tiltable three-wheeled vehicle can be self-standing on an inclined surface;

FIG. 12 is a view showing another embodiment of FIG. 2;

FIG. 13 is a view showing another embodiment of FIG. 3;

FIG. 14 is a view showing still another embodiment of FIG. 2; and

FIG. 15 is an operational view for explaining a mode in which a vehicle body is inclined based on a bank control of a vehicle body.

### DETAILED DESCRIPTION OF THE INVENTION

Embodiments of the invention will be described hereinafter with reference to the accompanying drawings. The drawings are viewed in the direction of symbols. Further, “front”, “rear”, “left”, “right”, “up”, “down” indicate directions as viewed from a driver.

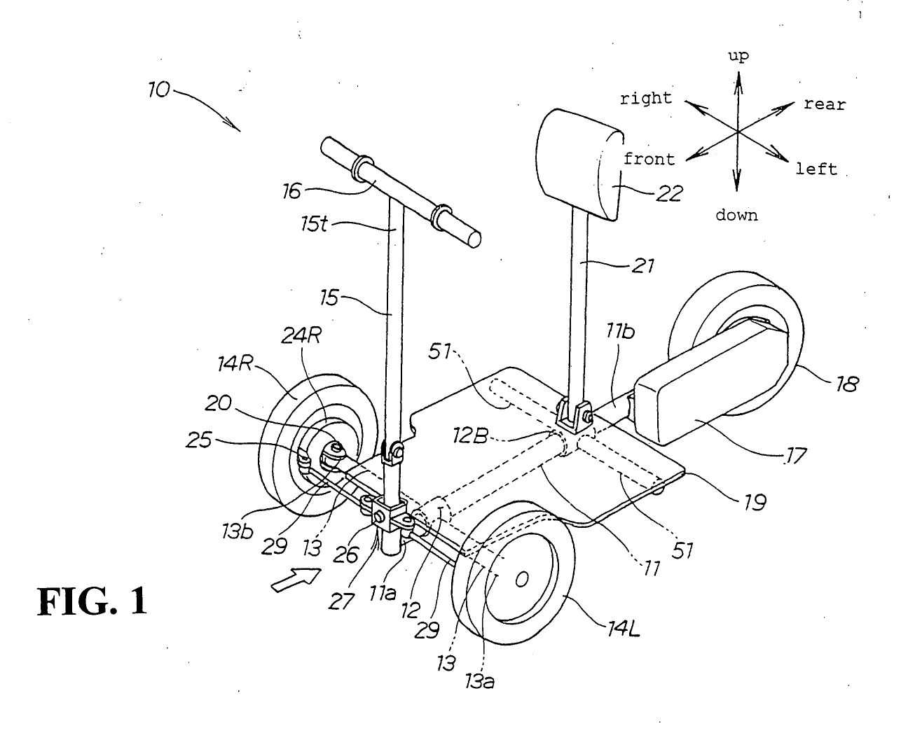

FIG. 1 is a perspective view of a tiltable three-wheeled vehicle according to the present invention. The tiltable three-wheeled vehicle 10 includes a center frame 11 which extends from a front side to a rear side of a vehicle body, cross shafts 13, 13 which extend in left and right sides by way of a rotary member 12 which is fitted on a front portion 11a of the center frame 11, and left and right front wheels 14L, 14R which are rotatably mounted on left and right ends 13a, 13b of the cross shafts 13, 13. Further, the tiltable three-wheeled vehicle 10 includes a manipulating member 15 which is steerably mounted on a front portion 11a of the center frame 11 wherein the manipulating member 15 extends upwardly and a handle 16 which is mounted on an upper end 15t of the manipulating member 15 in a state that the handle 16 extends in the left and right sides.

The tiltable three-wheeled vehicle includes a power unit 17 which is mounted on a rear portion 11b of the center frame 11, a rear wheel 18 which is mounted on the power unit 17 and driven by the power of the power unit 17, and a floor plate 19 arranged between the front wheels 14L, 14R and the rear wheel 18 and on which a rider rides.

Hub drums 24R (the hub drum on a left side not shown in the drawing) are mounted on the left and right ends 13a, 13b of the cross shafts 13 by way of steering pins 20 (the steering pin on a left side not shown in the drawing).

Rider support bar 21 supports the driver and back rest 22 supports a posture of the driver.

The left and right front wheels 14L, 14R and the floor plate 19 comprise a non-tilting portion which exhibits a camber of zero during turning and, at the same time, the rear wheel 18 is steered by tilting the manipulating member 15 in either left or right direction from an upright position. Here, cross shafts 51, 51 are provided to a rear portion of the floor plate 19.

The rotary member 12, which is rotatable about an axis of the center frame 11, is formed on the center frame 11, which extends in the fore-and-aft direction of the vehicle. The floor plate 19 and the cross shafts 13, 13 which cross the center frame 11 at a right angle are fixed to the rotary member 12. The left and right front wheels 14L, 14R are mounted on left and right ends 13a, 13b of the cross shafts 13, 13. One rear wheel 18 is mounted on the rear portion 11b of the center frame 11 by way of the power unit 17. The manipulating member 15 which a driver manipulates is erected on the front portion 11a of the center frame 11. The front wheels 14L, 14R maintain a zero camber and the center frame 11 and the rear wheel 18 constitute a tilting portion with respect to the front wheels 14L, 14R and the floor plate 19 by way of the rotary member 12.

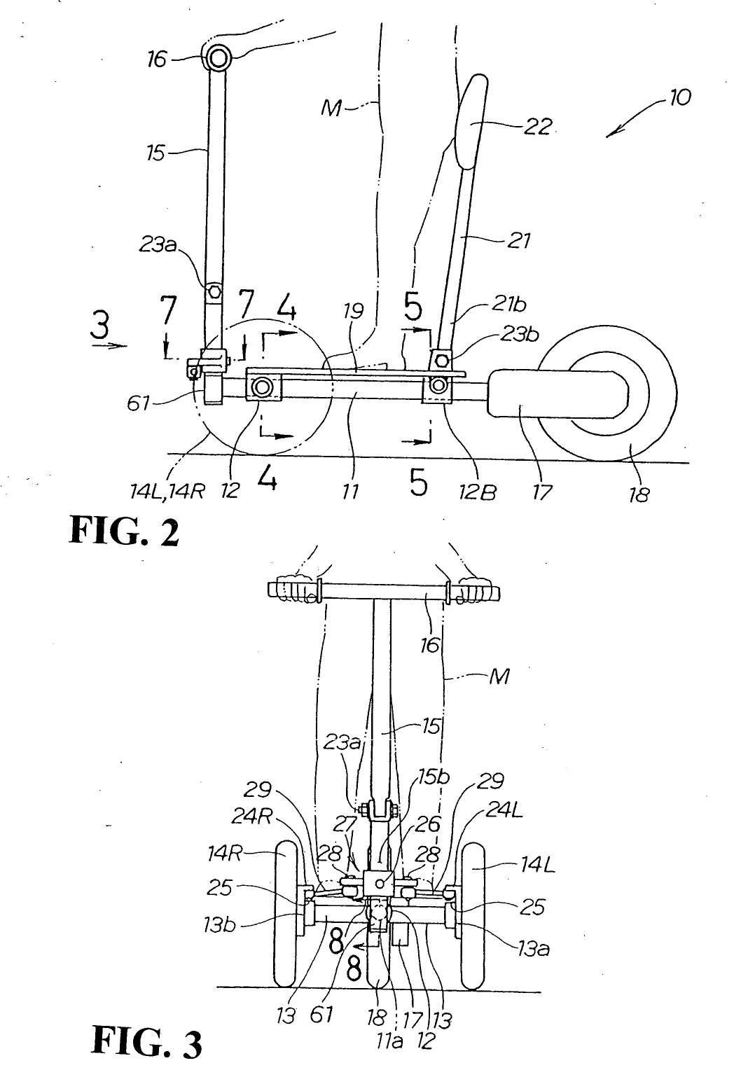

FIG. 2 is a side view of the tiltable three-wheeled vehicle according to the present invention. The front and rear rotary members 12, 12B are provided on the center frame 11 and the front and rear cross shafts 13, 13 . . . ( . . . meaning plurals), 51 . . . extend in the front/rear direction. Cross shafts 13 . . . , 51 . . . and rotary members 12, 12B are mounted on the floor plate 19. Here, M indicates a driver.

The manipulating member 15 has a collapsible structure and constitutes a member which is foldable at a position of a fixing shaft 23a formed on a middle portion of the manipulating member 15. A driver support bar 21 also has a collapsible structure and constitutes a member which is foldable at a position of a fixing shaft 23b formed on a lower end portion 21b of the driver support lever 21.

By folding the manipulating member 15 and the driver support lever 21 or by adopting the dividable structure by forming the fixing shafts 23a, 23b using bolts or the like and removing these fixing shafts 23a, 23b, it is possible to make the tiltable three-wheeled vehicle 10 more compact whereby the tiltable three-wheeled vehicle is suitable also for mounting in an automobile or the like.

FIG. 3 is a view as viewed from an arrow 3 in FIG. 2 and shows the structure of the front wheels 14L, 14R and a periphery of cross shaft 13.

Hub drums 24L, 24R are mounted on left and right ends of the cross shaft 13 and the front wheels 14L, 14R are rotatably mounted on the hub drums 24L, 24R.

Next, the manipulating member 15 is provided above the front portion 11a of the center frame 11, a rotary shaft 26 and a bracket 27 are mounted on a lower portion 15b of the manipulating member 15, tie rods 29, 29 are mounted on the bracket 27 by way of connecting members 28, 28, and the tie rods 29, 29 are mounted on the hub drums 24L, 24R by way of connecting pins 25, 25 thus constituting a steering system around the front wheels 14L, 14R. The mounting structure of the bracket 27 on the manipulating member 15 is described later.

The left and right front wheels 14L, 14R are rotatably and steerably mounted on the cross shafts 13, 13 and the tie rods 29, 29 extend to the left side and the right side from the center-frame front portion 11a or the manipulating-member lower portion 15b. The tie rods 29, 29 are connected to the left and right front wheels 14L, 14R, whereby two front wheels 14L, 14R are rotatably steered when the manipulating member 15 is tilted to the left side or the right side.

In this embodiment, the manipulating member 15 is rotatably mounted on the center frame 11 and the front wheels 14L, 14R can be steered by imparting a steering angle to the handle 16.

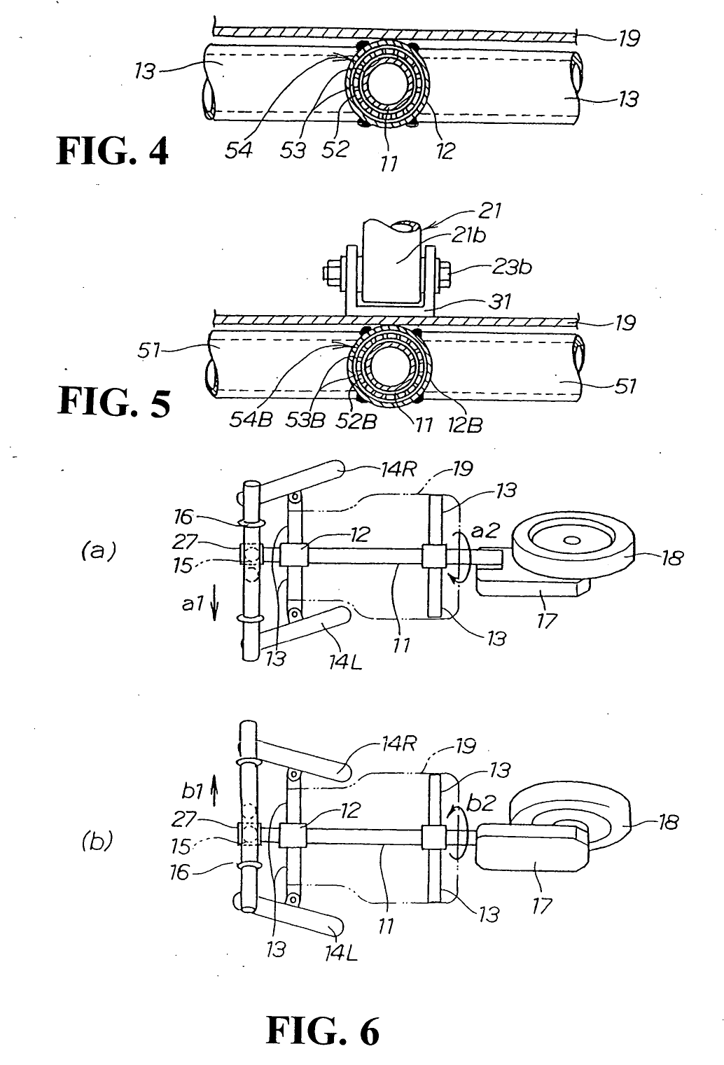

FIG. 4 is a cross-sectional view taken along a line 4-4 in FIG. 2 and is a view for explaining the structure around the front cross shaft.

The rotary member 12 is provided on the center frame 11 and the cross shafts 13, 13 are fixed to left and right portions of the rotary member 12. Further, a bearing member 54 is interposed between the center frame 11 and the rotary member 12. The bearing member 54 comprises balls 52 . . . and retainer members 53 . . . .

Here, the cross shafts 13, 13 are members for mounting the front wheels.

The weight of the cross shafts 13, 13 is reduced by adopting the pipe structure. Further, although the joining of the respective members is performed by welding, provided that given strength and durability are satisfied, the joining using an adhesive agent may also be applicable depending on portions.

Here, the floor plate 19 is arranged above the rotary member 12.

FIG. 5 is a cross-sectional view taken along a line 5-5 in FIG. 2 and is a view for explaining the structure around the rear cross shaft.

The rotary member 12B is provided on the center frame 11 and the cross shafts 51, 51 are fixed to left and right portions of the rotary member 12B. Further, a bearing member 54B is interposed between the center frame 11 and the rotary member 12B. The bearing member 54B comprises balls 52B . . . and retainer members 53B . . . .

The rear cross shafts 51, 51 support the floor plate 19. Bracket 31 is provided for mounting the driver support bar 21 in a collapsible manner.

FIG. 6 is an operation view when the rear wheel is inclined.

FIG. 6(a) is a view for explaining the manipulation for inclining the rear wheel 18 to the left side to perform the left turning, wherein when the handle 16 is moved in the direction of an arrow a1 in the drawings, the center frame 11 is rotated in the direction of an arrow a2 in the drawing by way of the manipulating member 15 and, at the same time, the rear wheel 18 which is mounted on the center frame 11 is tilted to the left side whereby the left turning can be performed.

FIG. 6(b) is a view for explaining the manipulation for inclining the rear wheel 18 to the right side to perform the right turning, wherein when the handle 16 is moved in the direction of an arrow b1 in the drawings, the center frame 11 is rotated in the direction of an arrow b2 in the drawing by way of the manipulating member 15 and, at the same time, the rear wheel 18 which is mounted on the center frame 11 is tilted to the right side whereby the right turning can be performed.

Since it is possible to allow one rear wheel 18 to tilt in the turning direction by tilting the manipulating member 15 to either of left side and the right side, the vehicle exhibits improved turning performance.

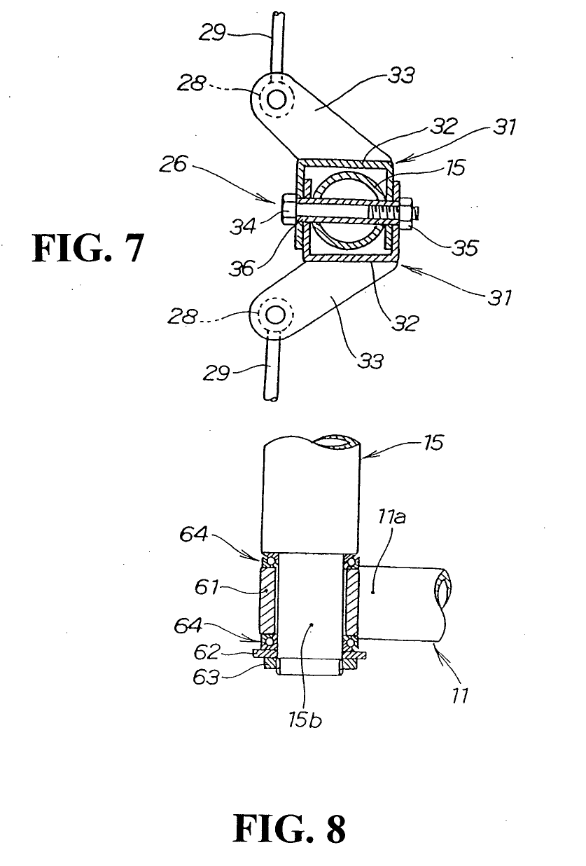

FIG. 7 is a cross sectional view taken along a line 7-7 in FIG. 2 and is a view for explaining the structure of the steering portion.

On the manipulating member 15, brackets 31, 31 each of which has a mounting portion 32 having a U-shaped cross section and a flange portion 33 are mounted.

These brackets 31, 31 are rotatably mounted with respect to the manipulating member 15 using the rotary shaft 26. The rotary shaft 26 is a member which comprises a penetration bolt 34, a collar 36 and a nut 35. Here, the collar 36 is provided on a shaft of the penetration bolt 34, the brackets 31, 31 are arranged to face each other in an opposed manner to surround the manipulating member 15, the manipulation bolt 34 and the collar 36 are allowed to penetrate the manipulating member 15, and the brackets 31, 31 are mounted by a nut 35.

On the left and right flange portion 33, 33, the tie rods 29, 29 which are provided as members for transmitting a force for steering the front wheels by way of the connecting members 28, 28 are mounted.

FIG. 8 is a cross-sectional view taken along a line 8-8 in FIG. 3. Head pipe 61 is rotatable with respect to the center frame 11 by the manipulating member 15 and is provided between a lower portion 15b of the manipulating member and a front portion 11a of the center frame. The head pipe 61 is fixed to the front portion 11a of the center frame.

To be more specific, the head pipe 61 is fixed to the front portion 11a of the center frame, the lower portion 15b of the manipulating member is inserted into the head pipe 61 and the manipulating member 15 is fixed rotatably with respect to the head pipe 61 using the nut 62 and a lock nut 63. Bearings 64, 64 are provided above and below the head pipe 61. This allows a smooth rotation of the manipulating member 15 with respect to the head pipe 61.

In this manner, by rotatably mounting the manipulating member 15 with respect to the center frame 11, it is possible to impart a steering angle to the handle 16 whereby the front wheels 14L, 14R (see FIG. 3) can be steered.

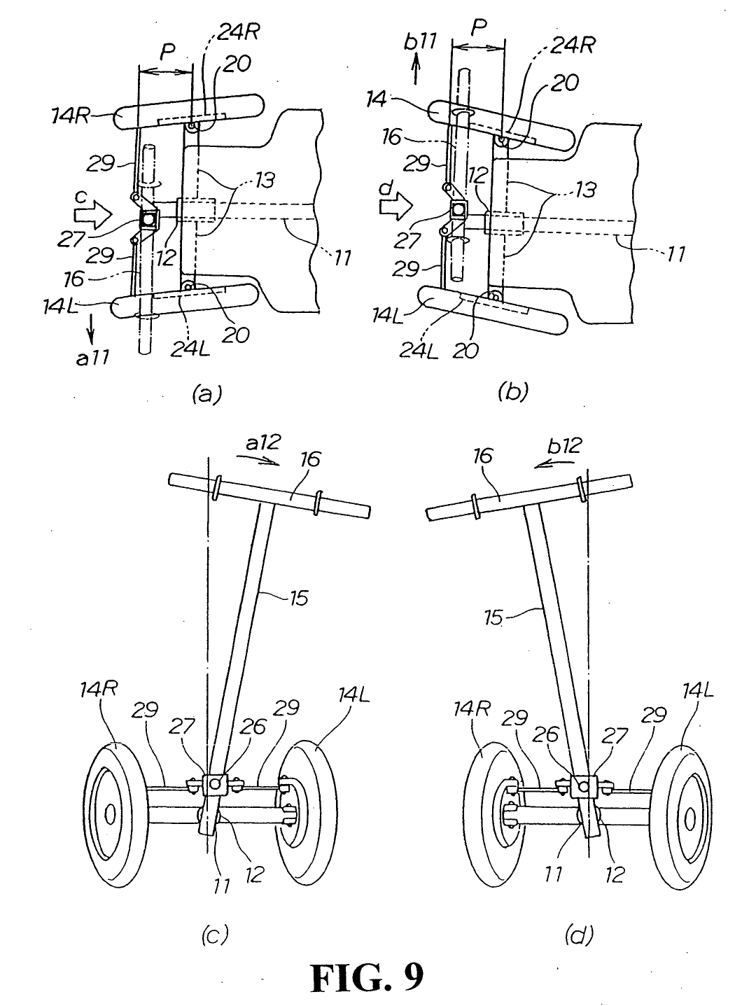

FIG. 9 is an operation view showing states in which the front wheels are steered when the frame is tilted.

FIG. 9(a) depicts a state in which the front wheels are steered to the left side due to the tilting of the frame, and FIG. 9(b) depicts a state in which the front wheels are steered to the right side due to the tilting of the frame. FIG. 9(c) is a view as viewed from an arrow c in FIG. 9(a). FIG. 9(d) is a view as viewed from an arrow d in FIG. 9(b).

In FIG. 9(a), when the handle 16 is moved in the direction of an arrow a11, the center frame 11 is rotated in the direction of an arrow a12 about the rotary member 12 and, at the same time, the manipulating member 15 which is integrally formed with the center frame 11 is tilted in the direction a12 and a force which pushes and pulls the front wheels 14L, 14R is added to the front wheels 14L, 14R through the tie rods 29, 29 mounted on a bracket 31 and hence, the front wheels 14L, 14R are tilted to the left side.

In FIG. 9(b), when the handle 16 is moved in the direction of an arrow b11, the front wheels 14L, 14R are steered to the right side.

To be more specific, in FIG. 9(c), the right tie rod 29 pulls the right front wheel 14R and the left tie rod 29 pushes the left front wheel 14L.

In FIG. 9(d), the right tie rod 29 pushes the right front wheel 14R and the left tie rod 29 pulls the left front wheel 14L.

Since the tie rods 29, 29 are mounted on the hub drums 24L, 24R spaced apart from the steering pins 20, 20 of the front wheels 14L, 14R by a pitch P, the hub drums 24L, 24R receive forces through the tie rods 29, 29 and hence, the front wheels 14L, 14R are rotated to the left side and the right side about the steering pins 20, 20.

As a result, by tilting the handle 16 without rotating the handle 16 in the left and right directions, it is possible to steer the front wheels 14L, 14R.

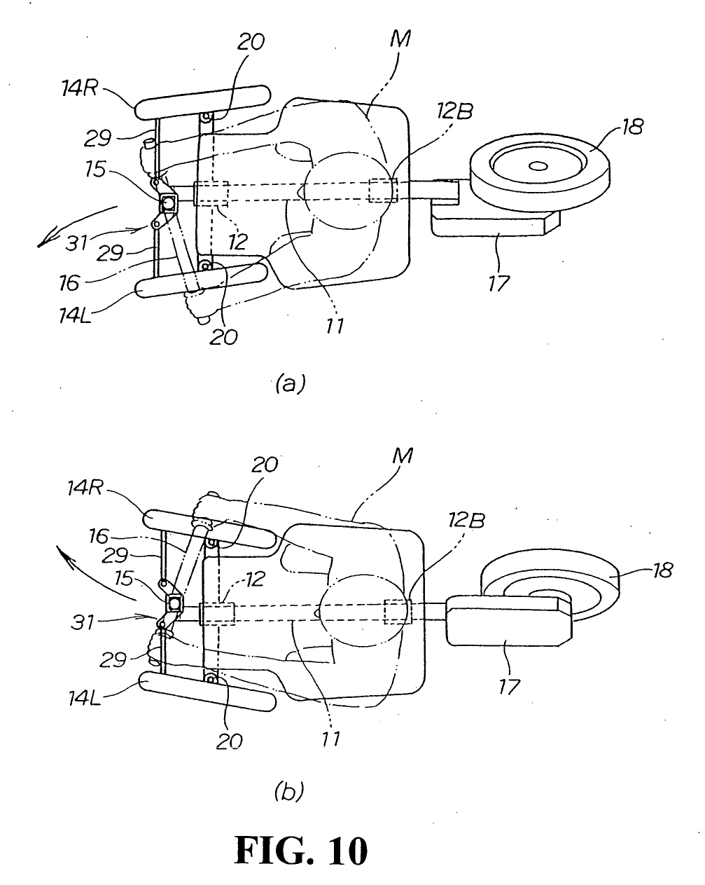

FIG. 10 is an operational view of the tiltable three-wheeled vehicle and shows a state in which the driver M turns the vehicle 10 by tilting the manipulating member 15 by way of the handle 16.

FIG. 10(a) shows a case when vehicle 10 is turned to the left side, wherein the driver M tilts the manipulating member 15 in the downward direction in the drawing thus applying forces to the front wheels 14L, 14R in the left side with respect to the steering pins 20 through the brackets 31 mounted on the manipulating member 15 and the tie rods 29, 29, whereby the front wheels 14L, 14R are steered to the left side about the steering pins 20 and, at the same time, the rear wheel 18 is tilted to the left side by way of the center frame 11.

In addition to the above, the steering can be performed even when the left-side steering angle is imparted to the handle 16 and hence, it is possible to impart the steering angle in an auxiliary manner whereby the turning performance can be increased and the turning radius can be decreased.

FIG. 10(b) shows a case when vehicle 10 is turned to the right side, wherein the driver M tilts the manipulating member 15 in the upward direction in the drawing thus applying forces to the front wheels 14L, 14R in the right side with respect to the steering pins 20 through the brackets 31 mounted on the manipulating member 15 and the tie rods 29, 29, whereby the front wheels 14L, 14R are steered to the right side about the steering pins 20 and, at the same time, the rear wheel 18 is tilted to the right side by way of the center frame 11.

In addition to the above, the steering can be performed even when the right-side steering angle is imparted to the handle 16 and hence, it is possible to impart the steering angle in an auxiliary manner whereby the turning performance can be increased and the turning radius can be decreased.

Further, the vehicle 10 is configured such that the tie rods 29, 29 are extended toward the left and right front wheels 14L, 14R from the manipulating member 15 and are connected to the left and right front wheels 14L, 14R and hence, when the manipulating member 15 is tilted to either one of the left side and the right side, the left and right front wheels 14L, 14R are steered.

The left and right front wheels 14L, 14R are configured to be steered and, at the same time, the rear wheel 18 can be tilted in the turning direction and hence, it is possible to direct all three wheels in the turning direction.

As a result, the vehicle's turning performance is improved.

Returning to FIG. 3, the manipulating member 15 is fixed to the front portion of the center frame 11 and one rear wheel 18 is mounted on the rear portion of the center frame 11 by way of the power unit 17. The rear wheel 18 is tilted by an amount corresponding to the tilting of the manipulating member 15. Accordingly, when the manipulating member 15 is erected upright, the camber of one rear wheel 18 becomes zero. The cambers of the left and right front wheels 14L, 14R are held at zero and hence, it is possible to make the vehicle body self-standing even when the vehicle 10 is stopped in accordance with the driver's intension.

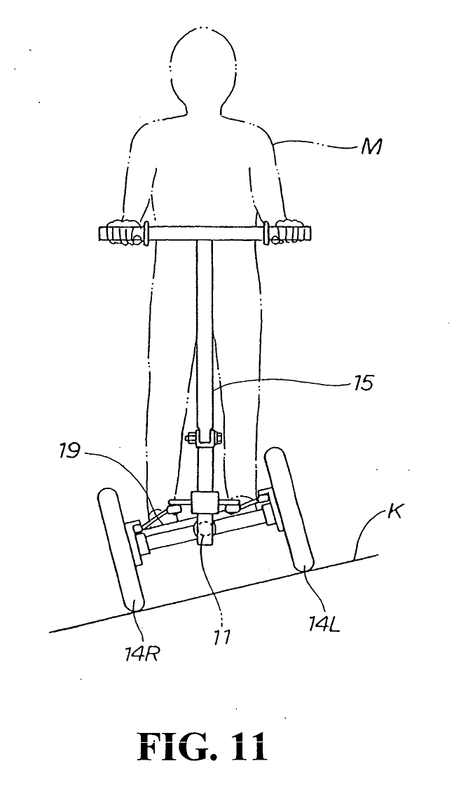

FIG. 11 is an operational view for explaining that the tiltable three-wheeled vehicle can achieve the self-standing posture on an inclined surface and shows that the driver M can allow the vehicle to assume the self-standing posture by tilting the manipulating member 15 in the perpendicular direction along which the gravity is applied so as to take the balance. On a surface K, which is inclined in the lateral direction, portions other than the periphery of the front wheels 14L, 14R and the floor plate 19 are rotated about the center frame 11. Here, the cambers of the front wheels 14L, 14R and the floor plate 19 are set to zero.

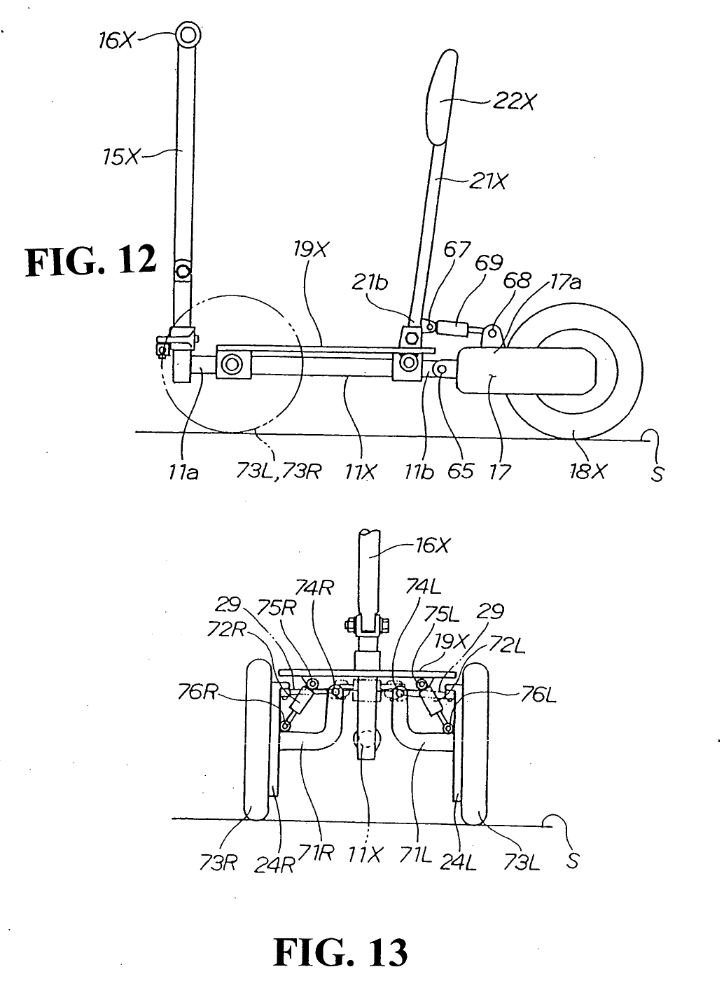

FIG. 12 is a view showing another embodiment of the tiltable three-wheeled vehicle shown in FIG. 2. In this embodiment, a pivot shaft 65 is provided in the vicinity of the rear end 11b of the center frame 11 and the power unit 17 is arranged in a rotatable manner about the pivot shaft 65 and, at the same time, a rear cushion 69 is provided between the lower end portion 21b of the support bar and an upper portion 17a of the power unit 17. Here, the rear cushion 69 and the lower end portion 21b are rotatably mounted by a fastening shaft 67, while the rear cushion 69 and the upper portion 17a are rotatably mounted by a fastening shaft 68.

Since the pivot shaft 65 and the rear cushion 69 are interposed between the rear wheel 18X and the floor plate 19X, there is no possibility that the unevenness of a traveling surface S is directly transmitted to the floor plate 19X whereby improving driving comfort.

FIG. 13 is a view showing an embodiment of the tiltable three-wheeled vehicle shown in FIG. 3. In this embodiment, swing arms 71L, 71R and left and right front cushions 72L, 72R are provided between the left and right hub drums 24L, 24R and the floor plate 19X.

Fastening shafts 74L, 74R rotatably support the swing arms 71L, 71R and the floor plate 19X. Fastening shafts 75L, 76L fasten front cushion 72L and fastening shafts 75R, 76R fasten front cushion 72R.

By setting the height of the fastening shafts 74L, 74R with respect to the traveling surface S substantially equal to the height of the tie rods 29, 29, it is possible to make the steering angle stable with respective to the vertical movement of the front wheels 73L, 73R.

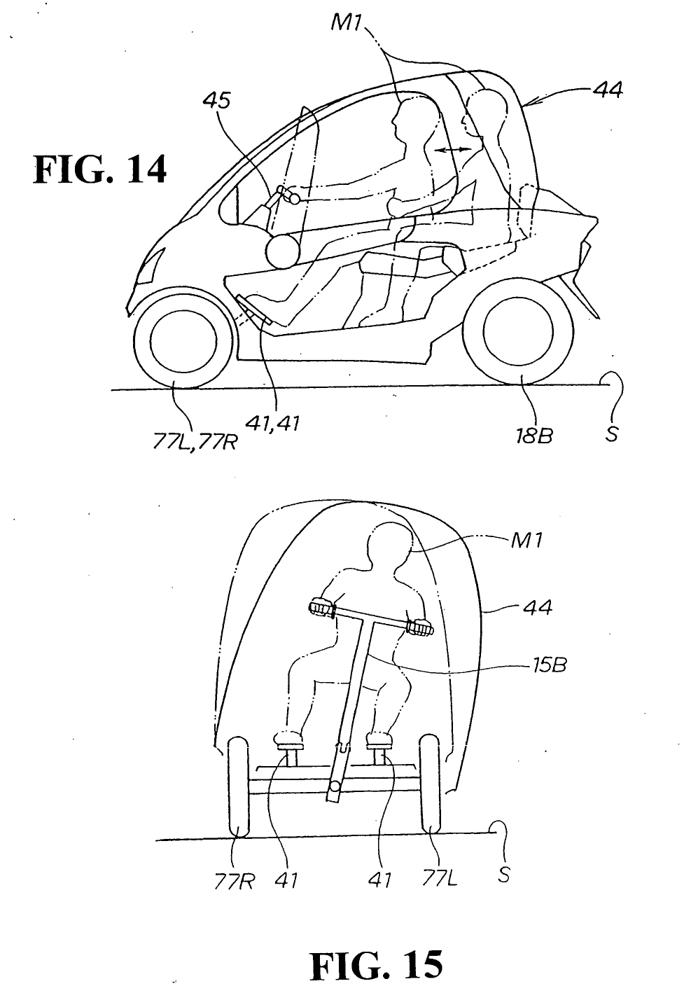

FIG. 14 is a view showing an embodiment of the tiltable three-wheeled vehicle shown in FIG. 2 whereby the tiltable three-wheeled vehicle is an all-weather vehicle.

The tilting manipulation of the manipulating members not shown in the drawing is performed such that bank control pedals 41, 41 which are respectively formed corresponding to a right leg and a left leg are used, and by adjusting step-in amounts of the pedals 41, 41, the cambers of the front wheels are maintained in accordance with the driver's intension so as to make the vehicle self-standing thus obtaining the favorable turning performance with the weight shift or the handle manipulation. Numeral 44 indicates a vehicle body.

FIG. 15 is an operational view for explaining a mode in which the vehicle body is tilted by the bank control of the vehicle body.

Power assist means such as a hydraulic or electrically-operated motor is moved based on the step-in amounts of the pedals 41, 41 and a force applied to a manipulating member 15B is adjusted by the power assist means whereby the self-standing and the turning operation can be performed. Here, in performing the turning operation, it is possible to set the camber of the front wheels with respect to a ground to zero using sensors.

Also, because the left and right front wheels are steered, the installation of the left and right tie rods which are connected from the front portion of the center frame or the lower portion of the manipulating member to the front wheels is arbitrary. That is, there is no problem even when the front-wheel steering mechanism is omitted.

Although the embodiment of the present invention has been described in detail, it will be understood that the present invention is not limited to the above-described embodiments, and various modifications in design may be made without departing from the spirit and scope of the invention defined in the claims.

We claim:

1. A tiltable three-wheeled vehicle having left and right front wheels and a rear wheel, said vehicle comprising:
a center frame extending in a lengthwise direction of the vehicle;
a rotary member supported on said center frame and rotatable with respect thereto about an axis of said center frame,
a floor plate attached to said rotary member,
a cross shaft attached to said rotary member such that said cross shaft is substantially perpendicular to said center frame, wherein opposing left and right ends of said cross shaft support the left and right front wheels to maintain a zero camber;
a power unit attached to said center frame for supporting the rear wheel on a rear portion of said center frame; and
a manipulating member attached to a front portion of said center frame,
wherein said center frame, said power unit and the rear wheel are tiltable with respect to said cross shaft, said rotary member, said floor plate and the left and right front wheels.

2. The tiltable three-wheeled vehicle according to claim 1 further comprising tie rods, wherein said tie rods extend in the left-and-right direction from a front portion of said center frame or a lower portion of said manipulating member, and said tie rods are attached to the left and right front wheels, whereby the left and right front wheels are configured to be steered when said manipulating member is inclined to the left or to the right.
